(19) United States
(12) Patent Application Publication
(10) Pub. No.: US 2018/0210442 A1
(43) Pub. Date: Jul. 26, 2018

(54) SYSTEMS AND METHODS FOR CONTROLLING A VEHICLE USING A MOBILE DEVICE

(71) Applicant: QUALCOMM Incorporated, San Diego, CA (US)

(72) Inventors: Feng Guo, San Diego, CA (US); Ananthapadmanabhan Arasanipalai Kandhadai, San Diego, CA (US)

(21) Appl. No.: 15/413,009

(22) Filed: Jan. 23, 2017

(51) Int. Cl. G05D 1/00; G06F 3/0488; G06F 3/0481

(52) U.S. Cl. CPC G05D 1/0038; G05D 1/0016; G06F 3/04815; G06F 3/0488

(57) ABSTRACT

A method operable on a mobile device is described. The method includes receiving a three-dimensional (3D) surround video feed from a vehicle. The 3D surround video feed includes a 3D surround view of the vehicle. The method also includes receiving a user input on a touchscreen indicating vehicle movement based on the 3D surround view. The method further includes converting the user input to a two-dimensional (2D) instruction for moving the vehicle. The 2D instruction includes a motion vector mapped to a ground plane of the vehicle.

### TECHNICAL FIELD

The present disclosure relates generally to communications. More specifically, the present disclosure relates to systems and methods for controlling a vehicle using a mobile device.

### BACKGROUND

Electronic devices (cellular telephones, wireless modems, computers, digital music players, Global Positioning System units, Personal Digital Assistants, gaming devices, etc.) have become a part of everyday life. Small computing devices are now placed in everything from vehicles to housing locks. The complexity of electronic devices has increased dramatically in the last few years. For example, many electronic devices have one or more processors that help control the device, as well as a number of digital circuits to support the processor and other parts of the device.

In some cases, a user may wish to remotely control a vehicle. For example, a user may wish to park an automobile while the user is in a remote location. As can be observed from this discussion, systems and methods to remotely control a vehicle by using a mobile device may be beneficial.

### SUMMARY

A method operable on a mobile device is described. The method includes receiving a three-dimensional (3D) surround video feed from a vehicle. The 3D surround video feed includes a 3D surround view of the vehicle. The method also includes receiving a user input on a touchscreen indicating vehicle movement based on the 3D surround view. The method further includes converting the user input to a two-dimensional (2D) instruction for moving the vehicle. The 2D instruction includes a motion vector mapped to a ground plane of the vehicle.

The method may also include sending the 2D instruction to the vehicle. Converting the user input to the 2D instruction may include sending the user input to the vehicle. The vehicle may convert the user input from the 3D surround view to the 2D instruction. The 2D instruction may include an instruction to park the vehicle.

The method may also include displaying the 3D surround video feed on the touchscreen. Converting the user input to the 2D instruction may include mapping the user input in the 3D surround view to a motion vector in a 2D bird's-eye view of the vehicle.

Converting the user input to the 2D instruction may include determining a first motion vector based on the user input on the touchscreen. A transformation may be applied to the first motion vector to determine a second motion vector that is aligned with a ground plane of the vehicle. The transformation may be based on a lens focal length of the 3D surround view.

Receiving the user input on the touchscreen indicating vehicle movement may include determining a displacement of a virtual vehicle model in the 3D surround view displayed on the touchscreen. The method may also include displaying a motion vector on the touchscreen corresponding to the converted user input.

A mobile device is also described. The mobile device includes a processor, a memory in communication with the processor and instructions stored in the memory. The instructions are executable by the processor to receive a 3D surround video feed from a vehicle, the 3D surround video feed comprising a 3D surround view of the vehicle. The instructions are also executable to receive a user input on a touchscreen indicating vehicle movement based on the 3D surround view. The instructions are further executable to convert the user input to a 2D instruction for moving the vehicle. The 2D instruction includes a motion vector mapped to a ground plane of the vehicle.

An apparatus is also described. The apparatus includes means for receiving a 3D surround video feed from a vehicle, the 3D surround video feed comprising a 3D surround view of the vehicle. The apparatus also includes means for receiving a user input on a touchscreen indicating vehicle movement based on the 3D surround view. The apparatus further includes means for converting the user input to a 2D instruction for moving the vehicle. The 2D instruction includes a motion vector mapped to a ground plane of the vehicle.

A computer readable medium storing computer executable code is also described. The executable code includes code for causing a mobile device to receive a 3D surround video feed from a vehicle, the 3D surround video feed comprising a 3D surround view of the vehicle. The executable code also includes code for causing the mobile device to receive user input on a touchscreen indicating vehicle movement based on the 3D surround view. The executable code further includes code for causing the mobile device to convert the user input to a 2D instruction for moving the vehicle. The 2D instruction includes a motion vector mapped to a ground plane of the vehicle.

### BRIEF DESCRIPTION OF THE DRAWINGS

FIG. 1 is a block diagram illustrating a system for controlling a vehicle using a mobile device;

FIG. 2 is a flow diagram illustrating a method for controlling a vehicle using a mobile device;

FIG. 3 is a diagram illustrating one example of a top plan view or bird's-eye view image visualization;

FIG. 4 is a diagram illustrating one example of a three-dimensional (3D) surround view;

FIG. 5 illustrates yet another example of a 3D surround view in accordance with the systems and methods disclosed herein;

FIG. 6 illustrates yet another example of a 3D surround view in accordance with the systems and methods disclosed herein;

FIG. 7 illustrates an example of a mobile device configured to control a vehicle in accordance with the systems and methods disclosed herein;

FIG. 8 is a flow diagram illustrating another method for controlling a vehicle using a mobile device;

FIG. 9 is a sequence diagram illustrating a procedure for controlling a vehicle using a mobile device;

FIG. 10 is a flow diagram illustrating yet another method for controlling a vehicle using a mobile device;

FIG. 11 is a sequence diagram illustrating another procedure for controlling a vehicle using a mobile device;

FIG. 12 illustrates different approaches to generating a 3D surround view;

FIG. 13 illustrates an approach to map points in a 3D surround view to a two-dimensional (2D) bird's-eye view;

FIG. 14 illustrates an approach to map a point in a 3D surround view to a 2D bird's-eye view;

FIG. 15 is a flow diagram illustrating a method for converting a user input on a touchscreen of a mobile device to a 2D instruction for moving a vehicle; and

FIG. 16 illustrates certain components that may be included within an electronic device.

### DETAILED DESCRIPTION

The described systems and methods provide a way to control a vehicle using a mobile device with an interactive 3D surround view. The user may use the mobile device as a remote control to maneuver the vehicle. The real-time video captured from a 3D surround view on the vehicle may be streamed to the mobile device. Thus, the user may use this feed to sense the environment and control the vehicle.

In an implementation, the mobile device may receive the 3D surround video feeds. To interactively maneuver the vehicle from the live video feeds, the user may manipulate a touch screen to move a virtual vehicle in a 3D surround view. Because the 3D surround view is a warped view with distortion, the mapped trajectory is not aligned with real scenes.

The control signal may be aligned using both the 3D surround view and a corresponding bird's-eye view to align the control signal. The motion vector (x, y, α) (2D translation and 2D rotation) from the 3D surround view may be pointed to ground on the bird's-eye view to generate the true motion control vectors.

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

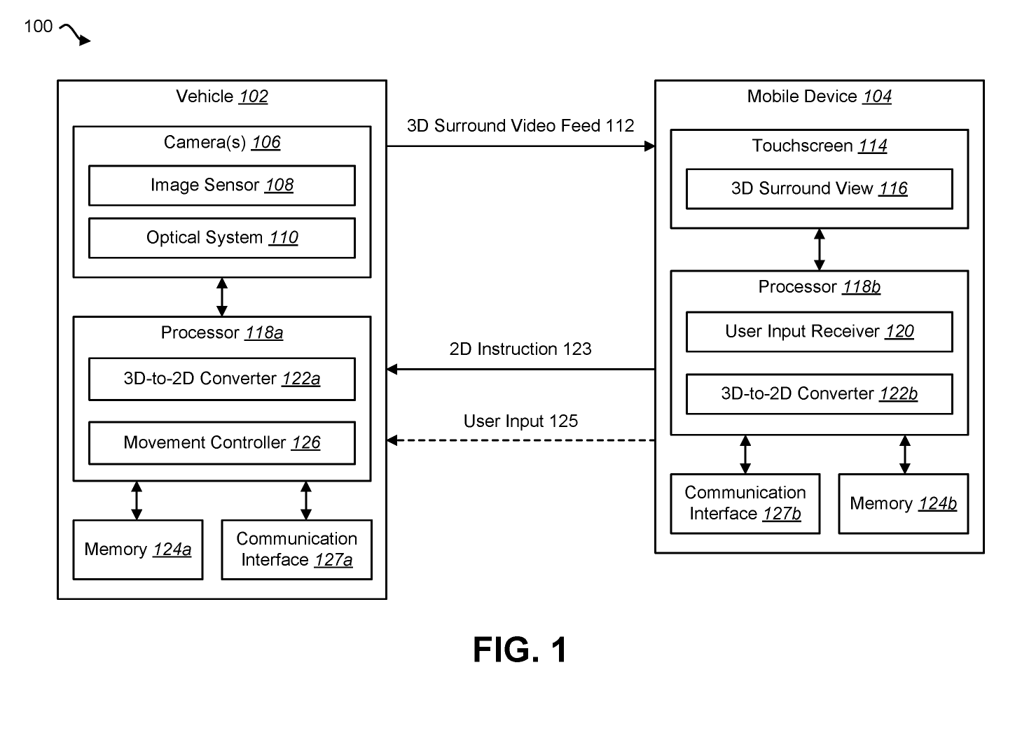

FIG. 1 is a block diagram illustrating a system 100 for controlling a vehicle 102 using a mobile device 104. The vehicle 102 may be a device or structure that is configured for movement. In an implementation, the vehicle 102 may be configured to convey people or goods. The vehicle 102 may be configured for self-propelled motion with two-dimensional (2D) freedom of movement. For example, the vehicle 102 may move on or by a steerable mechanism (e.g., wheels, tracks, runners, rudder, propeller, etc.). Examples of a land-borne vehicle 102 include automobiles, trucks, tractors, all-terrain vehicles (ATVs), snowmobiles, forklifts and robots. Examples of a water-borne vehicle 102 include ships, boats, hovercraft, airboats, and personal watercraft. Examples of air-borne vehicles 102 include unmanned aerial vehicles (UAVs) and drones.

The vehicle 102 may be capable of 2D movement. This includes translation (e.g., forward/backward and left/right) and rotation. The 2D movement of the vehicle 102 may be defined by one or more motion vectors. A 2D motion vector may be determined relative to the ground plane of the vehicle 102. The 2D motion vector may include a 2D translation component (e.g., X-axis coordinate and Y-axis coordinate) and a 2D rotation component (a). A motion vector may also be referred to as the trajectory of the vehicle 102.

In some circumstances, it may be desirable to control the vehicle 102 by a mobile device 104. For example, in the case of an automobile, a user may want to guide the vehicle 102 for parking at a drop off location or summoning the vehicle 102 from a parking lot using the mobile device 104 as a remote control. In the case of a boat, the user on a dock may wish to maneuver the boat for docking using the mobile device 104. Other examples include steering a robot around obstacles in an environment using the mobile device 104 as a remote control.

In an approach for controlling a vehicle 102, the vehicle 102 may perform fully autonomous movement. In this approach, the vehicle 102 performs essentially all or some of the steering and motion functions itself. This requires a complicated array of hardware, software and sensors (e.g., time-of-flight cameras, infrared time-of-flight cameras, interferometers, radar, laser imaging detection and ranging (LIDAR), sonic depth sensors, ultrasonic depth sensors, etc.) for perception of the vehicle's 102 environment. Many challenges are needed to be addressed with sensors for this approach. Also, unexpected stops or unintended movement can happen in this approach. An example of this approach is a fully autonomous automobile.

Another approach to controlling a vehicle 102 is semi-autonomous movement. In this approach, the vehicle 102 may be operated by a user to a certain location and then commanded to independently perform a procedure. An example of this approach is a self-parking automobile where a driver drives the automobile and finds a parking space. A parking system on the car will then automatically park the automobile in the parking space. As with the fully-autonomous approach, the semi-autonomous approach requires sophisticated sensors and control algorithms to be safely implemented, which may be technologically and economically unfeasible.

Another approach for controlling a vehicle 102 is a remote control (RC) car. In this approach, an operator observes a vehicle 102 and controls the movement of the vehicle 102 via a remote control device. This remote control device typically includes assigned user interface controls (e.g., joysticks, buttons, switches, etc.) to control the vehicle 102. However, this approach is limited to the field of view of the operator. Therefore, when the vehicle 102 is out of view of the operator, this approach is dangerous. Also, the vehicle 102 may obscure obstacles from the operator's field of view. For example, a large automobile may block the view of objects from being observed by the operator.

Another approach to controlling a vehicle 102 is a navigation system for unmanned aerial vehicles (UAVs). This approach uses expensive sensors and satellite communication to control the vehicle 102, which may be technologically and economically impractical for many applications. Also, this approach may not be functional in enclosed spaces (e.g., parking garages) where the signals cannot be transmitted.

Yet another approach to controlling a vehicle 102 is a first-person view from a camera mounted on the vehicle 102. For example, some drones send a video feed to a remote controller. However, this approach relies on pre-configured remote control input devices. Also the operator of the vehicle 102 in this approach has a limited field of view. With the first-person view, the operator cannot observe objects to the sides or behind the vehicle 102. This is dangerous when operating a large vehicle 102 (e.g., automobile) remotely.

The described systems and methods address these problems by using a mobile device 104 as a remote control that displays a 3D surround view 116 of vehicle 102. The mobile device 104 may be configured to communicate with the vehicle 102. Examples of the mobile device 104 include smart phones, cellular phones, computers (e.g., laptop computers, tablet computers, etc.), video camcorders, digital cameras, media players, virtual reality devices (e.g., headsets), augmented reality devices (e.g., headsets), mixed reality devices (e.g., headsets), gaming consoles, Personal Digital Assistants (PDAs), etc. The mobile device 104 may include one or more components or elements. One or more of the components or elements may be implemented in hardware (e.g., circuitry) or a combination of hardware and software (e.g., a processor with instructions).

In some configurations, the vehicle 102 may include a processor 118a, a memory 124a, one or more cameras 106 and/or a communication interface 127a. The processor 118a may be coupled to (e.g., in electronic communication with) the memory 124a, touchscreen 114, camera(s) 106 and/or the communication interface 127a.

The one or more cameras 106 may be configured to capture a 3D surround view 116. In an implementation, the vehicle 102 may include four cameras 106 located at the front, back, right and left of the vehicle 102. In another implementation, the vehicle 102 may include four cameras 106 located at the corners of the vehicle 102. In yet another implementation, the vehicle 102 may include a single 3D camera 106 that captures a 3D surround view 116.

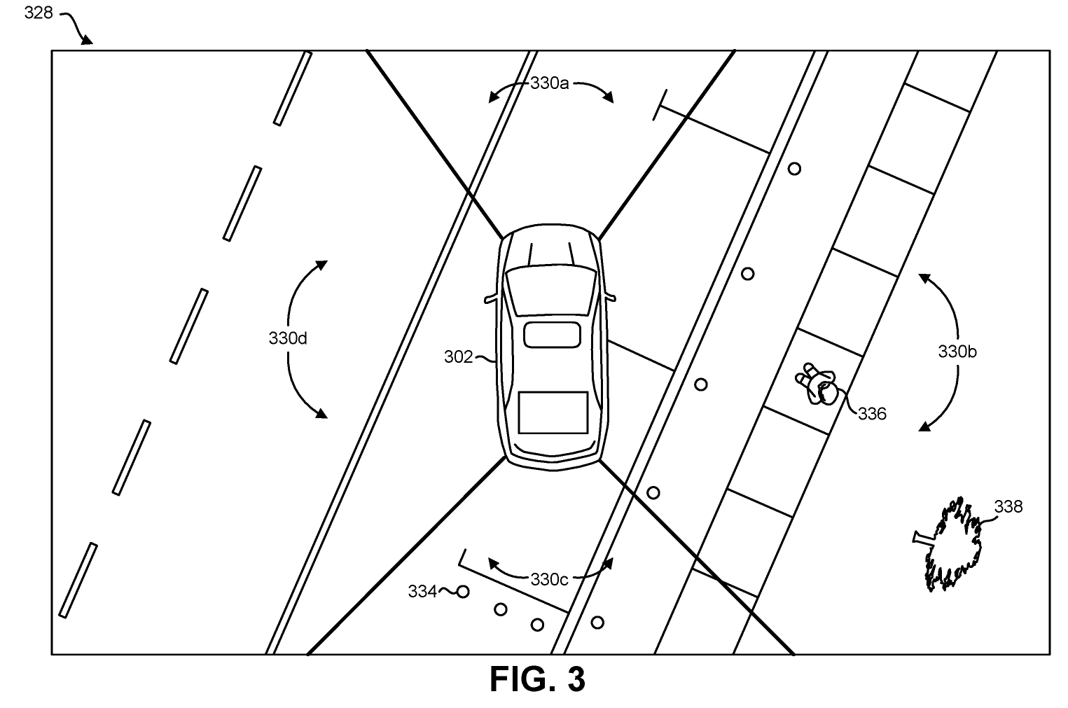

It should be noted that a 3D surround view 116 is preferable to a 2D bird's-eye view (BEV) of the vehicle 102 when being used by a user to maneuver the vehicle 102. As described in connection with FIG. 3, one disadvantage of the 2D bird's-eye view (also referred to as a top plan view) is that some objects may appear to be flattened or distorted and may lack a sense of height or depth. Compared with a 3D surround view 116, the non-ground-level objects, such as an obstacle, will have distortions in the 2D bird's-eye view. Also there are amplified variations in the farther surrounding areas of the 2D bird's-eye view. This is problematic for remotely operating a vehicle 102 based on an image visualization.

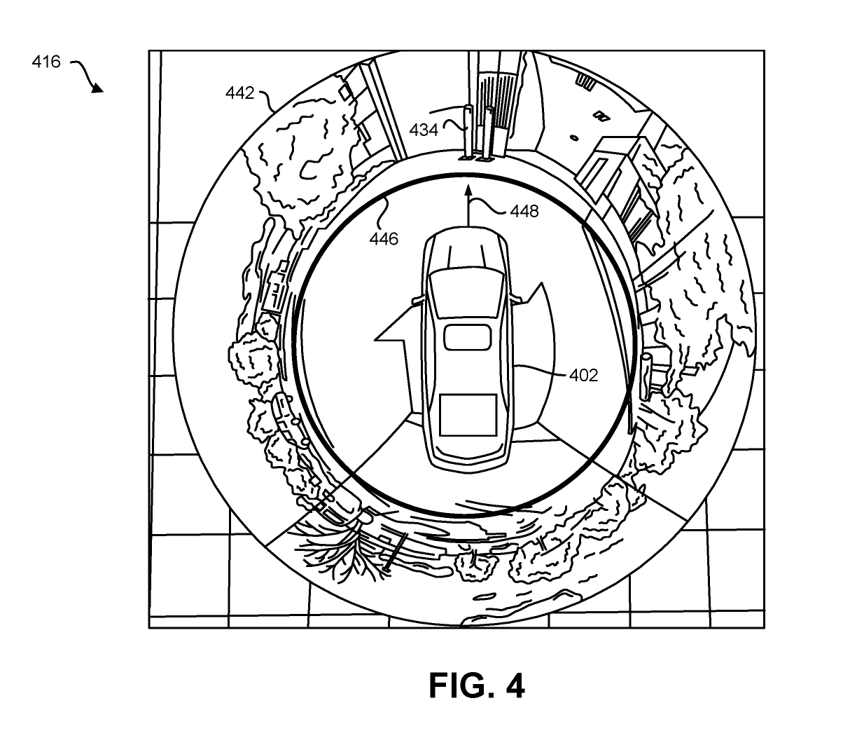

A 3D surround view 116 may be used to convey height information for objects within the environment of the vehicle 102. Warping the composite image in a distortion level by placing a virtual fisheye camera in the 3D view can cope with the problems encountered by a 2D bird's-eye view. Examples of the 3D surround view 116 are described in connection with FIGS. 4-6.

The vehicle 102 may obtain one or more images (e.g., digital images, image frames, video, etc.). For example, the camera(s) 106 may include one or more image sensors 108 and/or one or more optical systems 110 (e.g., lenses) that focus images of scene(s) and/or object(s) that are located within the field of view of the optical system(s) 110 onto the image sensor(s) 108. A camera 106 (e.g., a visual spectrum camera) may include at least one image sensor 108 and at least one optical system 110.

In some configurations, the image sensor(s) 108 may capture the one or more images. The optical system(s) 110 may be coupled to and/or controlled by the processor 118a. Additionally or alternatively, the vehicle 102 may request and/or receive the one or more images from another device (e.g., one or more external image sensor(s) 108 coupled to the vehicle 102, a network server, traffic camera(s), drop camera(s), automobile camera(s), web camera(s), etc.). In some configurations, the vehicle 102 may request and/or receive the one or more images via the communication interface 127a.

In an implementation, the vehicle 102 may be equipped with wide angle (e.g., fisheye) camera(s) 106. In this implementation, the camera(s) 106 may have a known lens focal length.

The geometry of the camera(s) 106 may be known relative to the ground plane of the vehicle 102. For example, the placement (e.g., height) of a camera 106 on the vehicle 102 may be stored. In the case of multiple cameras 106, the separate images captured by the cameras 106 may be combined into a single composite 3D surround view 116.

The communication interface 127a of the vehicle 102 may enable the vehicle 102 to communicate with the mobile device 104. For example, the communication interface 127a may provide an interface for wired and/or wireless communications with a communication interface 127b of the mobile device 104.

In some configurations, the communication interfaces 127 may be coupled to one or more antennas for transmitting and/or receiving radio frequency (RF) signals. Additionally or alternatively, the communication interfaces 127 may enable one or more kinds of wireline (e.g., Universal Serial Bus (USB), Ethernet, etc.) communication.

In some configurations, multiple communication interfaces 127 may be implemented and/or utilized. For example, one communication interface 127 may be a cellular (e.g., 3G, Long Term Evolution (LTE), Code Division Multiple Access (CDMA), etc.) communication interface 127, another communication interface 127 may be an Ethernet interface, another communication interface 127 may be a Universal Serial Bus (USB) interface, and yet another communication interface 127 may be a wireless local area network (WLAN) interface (e.g., Institute of Electrical and Electronics Engineers (IEEE) 802.11 interface). In some configurations, the communication interface 127 may send information to and/or receive information from another device.

The vehicle 102 may send a 3D surround video feed 112 to the mobile device 104. The 3D surround video feed 112 may include a series of image frames. An individual image frame may include a 3D surround view 116 captured by the camera(s) 106. In an implementation, the 3D surround video feed 112 may have a frame rate that simulates real motion (e.g., 24 frames per second (FPS)). In another implementation, the 3D surround video feed 112 frame rate may be slower to reduce image processing at the vehicle 102 and mobile device 104.

In some configurations, the mobile device 104 may include a processor 118b, a memory 124b, a touchscreen 114 and/or a communication interface 127b. The processor 118b may be coupled to (e.g., in electronic communication with) the memory 124b touchscreen 114, and/or the communication interface 127b. The processor 118b may also be coupled to one or more sensors (e.g., GPS receiver, inertial measurement unit (IMU)) that provide data about the position, orientation, location and/or environment of the mobile device 104.

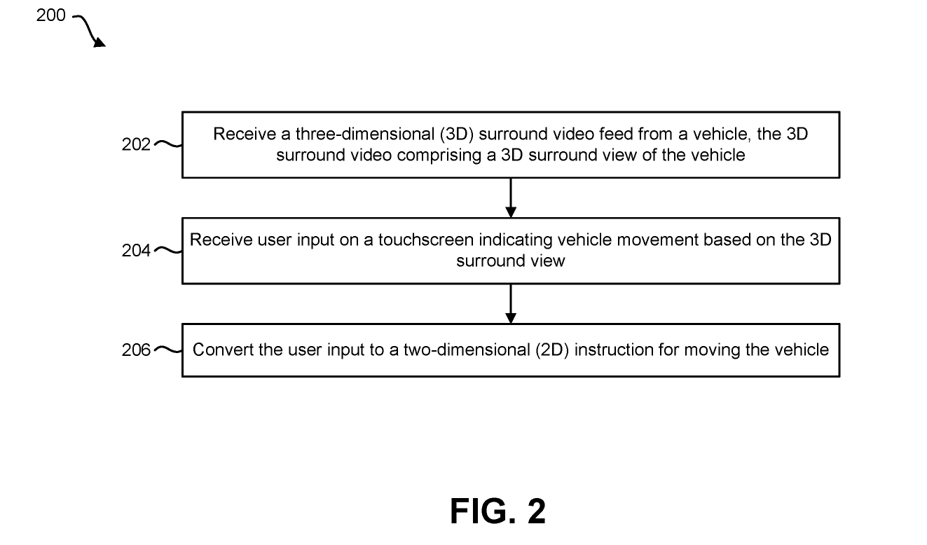

In some configurations, the mobile device 104 may perform one or more of the functions, procedures, methods, steps, etc., described in connection with one or more of FIGS. 2-15. Additionally or alternatively, the mobile device 104 may include one or more of the structures described in connection with one or more of FIGS. 2-15.

The mobile device 104 may include a touchscreen 114. The mobile device 104 may display an interactive 3D surround view 116 on the touchscreen 114. The operator (e.g., driver) may use the mobile device 104 as a remote control to maneuver the vehicle 102. The real-time 3D surround video feed 112 captured by a 3D surround view on the car may be streamed to the mobile device 104. The operator thus uses the 3D surround view 116 to sense the environment and control the vehicle 102.

In some configurations, the mobile device 104 may include an image data buffer (not shown). The image data buffer may buffer (e.g., store) image data from the 3D surround video feed 112. The buffered image data may be provided to the processor 118b. The processor 118b may cause the 3D surround view 116 to be displayed on the touchscreen 114 of the mobile device 104.

The orientation of the 3D surround view 116 on the touchscreen 114 may be configurable based on the desired direction of vehicle movement. For example, a default orientation of the 3D surround view 116 may be facing forward, with a forward view at the top of the touchscreen 114. However, if the user wishes to move the vehicle backward, the orientation of the 3D surround view 116 may be reversed such that the back view is located at the top of the touchscreen 114. This may simulate the user looking out the back of the vehicle 102. The orientation of the 3D surround view 116 may switch automatically based on the indicated direction of movement. Alternatively, the user may manually switch the 3D surround view 116 orientation.

The processor 118b may include and/or implement a user input receiver 120. The user of the mobile device 104 may interact with the touchscreen 114. In an implementation, the touchscreen 114 may include one or more sensors that detect physical touch on the touchscreen 114. For example, the user may user a finger, stylus or other object to enter a physical gesture (e.g., touch, multi-touch, tap, slide, etc.) into the touchscreen 114. The user input receiver 120 may receive the user input 125 detected at the touchscreen 114.

In another implementation, the user input receiver 120 may receive user input 125 corresponding to movement of the mobile device 104 relative to the 3D surround view 116 displayed on the touchscreen 114. If the mobile device 104 includes an IMU or other motion sensor (e.g., accelerometer), then the user may interact with the touchscreen 114 by moving the mobile device 104. The measured movement may be provided to the user input receiver 120.

The user may directly interact with the 3D surround view 116 displayed on the touchscreen 114 to indicate vehicle 102 movement. For example, the user may drag a finger across the touchscreen 114 to indicate where the vehicle 102 should move. In another example, the user may tap a location on the touchscreen 114 corresponding to a desired destination for the vehicle 102.

In an implementation, the mobile device 104 may display a virtual vehicle model in the 3D surround view 116 displayed on the touchscreen 114. The virtual vehicle model may be a representation of the actual vehicle 102 that is displayed within (e.g., in the center of) the 3D surround view 116. A user may indicate vehicle motion by dragging the virtual vehicle model within the 3D surround view 116. In this case, the user input receiver 120 may receive a displacement value of the virtual vehicle model in the 3D surround view 116.

The user may also indirectly interact with the 3D surround view 116 displayed on the touchscreen 114 to indicate vehicle 102 movement. For example, the user may turn the mobile device 104 one way or the other to indicate vehicle motion.

The processor 118b may also include and/or implement a 3D-to-2D converter 122b that converts the user input 125 to a 2D instruction 123 for moving the vehicle 102. To generate an accurate control signal for the 2D motion of the vehicle 102, a 2D instruction 123 should be aligned with the ground plane of the vehicle 102. However, the 3D surround view 116 is a warped view with distortion. Therefore, the mapped trajectory from the user input 125 is not aligned with real scenes.

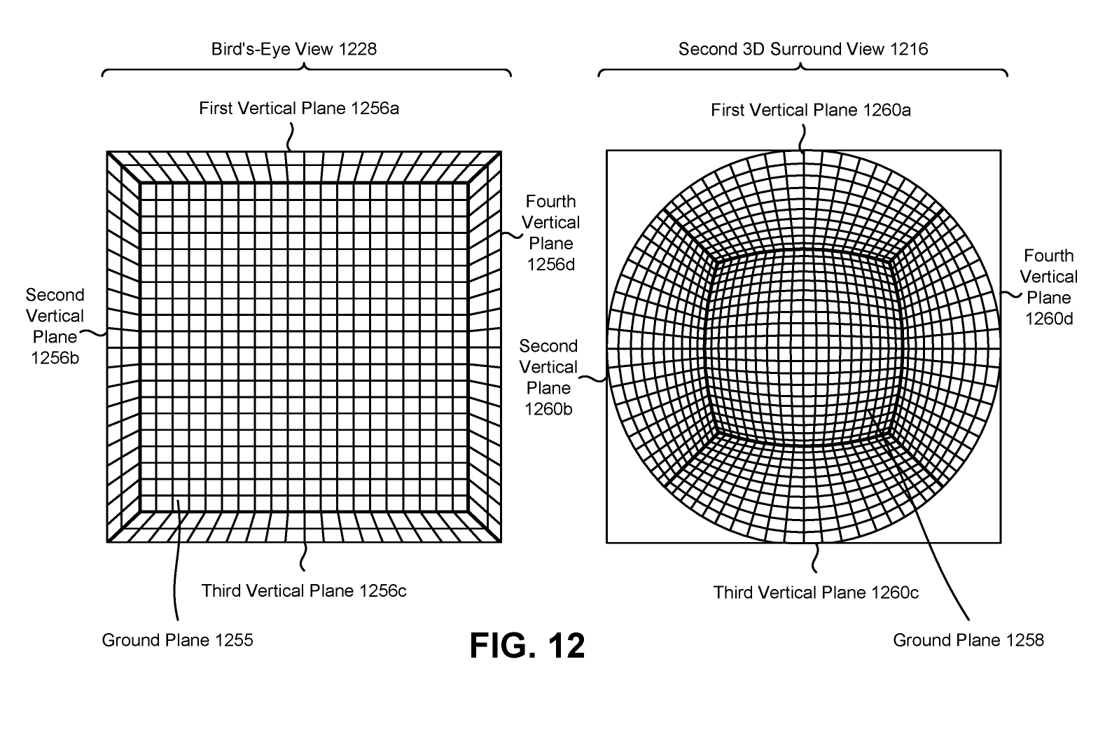

As described above, to interactively maneuver the vehicle 102, a 3D surround view 116 is used to provide height and depth visual information to the user on the touchscreen 114. However, since 3D view is a warped view with distortion, the mapped trajectory of the user input 125 is not aligned with real scenes. An example of this distortion is described in connection with FIG. 12.

The 3D-to-2D converter 122b may map the user input 125 in the 3D surround view 116 of the touchscreen 114 to a motion vector in a 2D bird's-eye view of the vehicle 102. To compensate for the distortion of the 3D surround view 116, the 3D-to-2D converter 122b may use the known geometry of the camera(s) 106 to convert from the 3D domain of the 3D surround view 116 to a 2D ground plane. Therefore, the mobile device 104 may be configured with the camera geometry of the vehicle 102. The vehicle 102 may communicate the camera geometry to the mobile device 104 or the mobile device 104 may be preconfigured with the camera geometry.

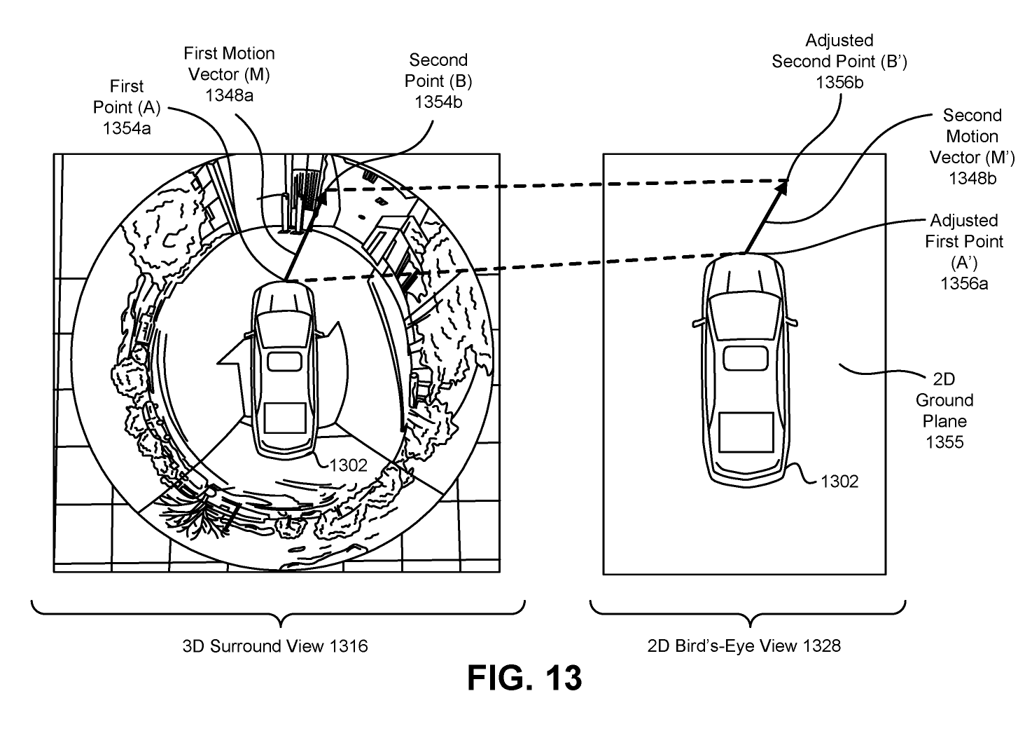

The 3D-to-2D converter 122b may use the 3D surround view 116 to align the user input 125 with the corresponding 2D bird's-eye view, producing a 2D instruction 123. In an implementation, the 2D instruction 123 may include a motion vector mapped to the ground plane of the vehicle 102. A motion vector (M, α) (2D translation and 2D rotation) from the 3D surround view 116 is pointed to ground on the 2D bird's-eye view to generate true motion control vectors (M′, α′). An example illustrating this approach is described in connection with FIG. 13.

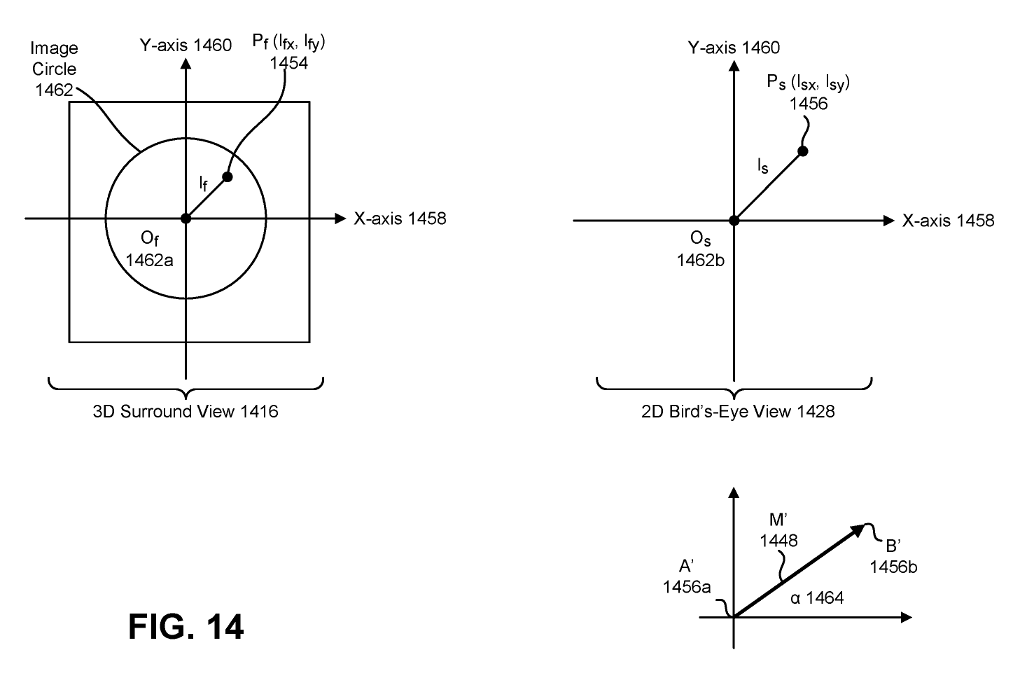

In an approach to converting the user input 125 to the 2D instruction 123, the 3D-to-2D converter 122b may determine a first motion vector based on the user input 125 on the touchscreen 114. For example, the 3D-to-2D converter 122b may determine the displacement of the virtual vehicle model in the 3D surround view 116 displayed on the touchscreen 114. The 3D-to-2D converter 122b may then apply a transformation to the first motion vector to determine a second motion vector that is aligned with a ground plane of the vehicle 102. The transformation may be based on the lens focal length of the 3D surround view 116. An example of this conversion approach is described in connection with FIG. 14.

In an implementation, the 2D instruction 123 may indicate a trajectory or angle of movement for the vehicle 102 to travel. For example, the 2D instruction 123 may instruct the vehicle 102 to move straight forward or backward. The 2D instruction 123 may also instruct the vehicle 102 to turn a certain angle left or right. Depending on the configuration of the vehicle 102, the 2D instruction 123 may instruct the vehicle 102 to pivot on an axis.

It should be noted that the 2D instruction 123 provides for a full range of 2D motion. Some approaches may only provide for one-dimensional motion (e.g., start/stop or forward/backward).

In another implementation, the 2D instruction 123 may instruct the vehicle 102 to travel to a certain location. For example, the user may drag the virtual vehicle model to a certain location in the 3D surround view 116 on the touchscreen 114. The 3D-to-2D converter 122b may determine a corresponding 2D motion vector for this user input 125. The 2D motion vector may include the translation (M′) (e.g., distance for the vehicle 102 to travel) and an angle (a′) relative to the current point of origin. The vehicle 102 may then implement this 2D instruction 123.

In yet another implementation, the 2D instruction 123 may also include a magnitude of the motion. For example, the 2D instruction 123 may indicate a speed for the vehicle 102 to travel based on the user input 125. The user may manipulate the touchscreen 114 to indicate different speeds. For instance, the user may tilt the mobile device 104 forward to increase speed. Alternatively, the user may press harder or longer on the touchscreen 114 to indicate an amount of speed.

In another implementation, the 2D instruction 123 may include an instruction to park the vehicle 102. For example, after maneuvering the vehicle 102 to a desired location, the user may issue a command to stop the motion of the vehicle 102 and enter a parked state. This may include disengaging the drive system of the vehicle 102 and/or shutting off the engine or motor of the vehicle 102.

The mobile device 104 may send the 2D instruction 123 to the vehicle 102. The processor 118a of the vehicle 102 may include and/or implement a movement controller 126. Upon receiving the 2D instruction 123 from the mobile device 104, the movement controller 126 may determine how to implement the 2D instruction 123 on the vehicle 102. For example, if the 2D instruction 123 indicates that the vehicle 102 is to turn 10 degrees to the left, the movement controller 126 may send a command to a steering system of the vehicle 102 to turn the wheels of the vehicle 102 a corresponding amount.

It should be noted that the remote control by the mobile device 104 described herein may be used independent of or in collaboration with other automated vehicle control systems. In one implementation, the vehicle 102 may be maneuvered based solely on the input (i.e., 2D instruction 123) provided by the mobile device 104. This is analogous to a driver operating a car while sitting at the steering wheel of the car.

In another implementation, the vehicle 102 may maneuver itself based on a combination of the 2D instruction 123 and additional sensor input. For example, the vehicle 102 may be equipped with proximity sensors that can deactivate the remote control from the mobile device 104 in the event that the vehicle 102 comes too close (i.e., within a threshold amount) of an object. In another implementation, the vehicle 102 may use the camera(s) 106 to perform distance calculations and/or object detection. The vehicle 102 may then perform object avoidance while implementing the 2D instruction 123.

The vehicle 102 may provide feedback to be displayed on the mobile device 104 based on the vehicle's sensor measurements. For example, if a proximity sensor determines that a user selected movement may result in a collision, the vehicle 102 may send a warning to be displayed on the touchscreen 114. The user may then take corrective action.

In another implementation, the vehicle 102 may convert the user input 125 to a 2D instruction instead of the mobile device 104. In this implementation, the mobile device 104 may receive the user input 125 at the touchscreen 114 as described above. The mobile device 104 may then send the user input 125 to the vehicle 102.

The processor 118a of the vehicle 102 may include and/or implement a 3D-to-2D converter 122a that converts the user input 125 to the 2D instruction for moving the vehicle 102. The conversion of the input 125 to the 2D instruction may be accomplished as described above.

The memory 124a of the vehicle 102 may store instructions and/or data. The processor 118a may access (e.g., read from and/or write to) the memory 124a. Examples of instructions and/or data that may be stored by the memory 124a may include image data, 3D surround view 116 data, user input 125 or 2D instructions 123, etc.

The memory 124b of the mobile device 104 may store instructions and/or data. The processor 118b may access (e.g., read from and/or write to) the memory 124b. Examples of instructions and/or data that may be stored by the memory 124b may include 3D surround view 116 data, user input 125, 2D instructions 123, etc.

The systems and methods described herein provide for controlling a vehicle 102 using a mobile device 104 displaying a 3D surround view 116. The described systems and methods provide an easy and interactive way to control an unmanned vehicle 102 without a complex system. For example, the described systems and methods do not rely on complex sensors and algorithms to guide the vehicle 102. Instead, the user may maneuver the vehicle 102 via the mobile device 104. The user may conveniently interact with the 3D surround view 116 on the touchscreen 114. This 3D-based user input 125 may be converted to a 2D instruction 123 to accurately control the vehicle movement in a 2D plane.

FIG. 2 is a flow diagram illustrating a method 200 for controlling a vehicle 102 using a mobile device 104. The method 200 may be implemented by a mobile device 104 that is configured to communicate with a vehicle 102.

The mobile device 104 may receive 202 a three-dimensional (3D) surround video feed 112 from the vehicle 102. The 3D surround video feed 112 may include a 3D surround view 116 of the vehicle 102. For example, the vehicle 102 may be configured with a plurality of cameras 106 that capture different views of the vehicle 102. The vehicle 102 may combine the different views into a 3D surround view 116. The vehicle 102 may send the 3D surround view 116 as a video feed to the mobile device 104.

The mobile device 104 may receive 204 user input 125 on a touchscreen 114 indicating vehicle movement based on the 3D surround view 116. For example, the mobile device 104 may display the 3D surround video feed 112 on the touchscreen 114. The user may interact with the 3D surround view 116 on the touchscreen 114 to indicate vehicle motion. In an implementation, the user may drag a virtual vehicle model within the 3D surround view 116 on the touchscreen 114. In an implementation, receiving the user input 125 on the touchscreen 114 indicating vehicle movement may include determining a displacement of the virtual vehicle model in the 3D surround view 116 displayed on the touchscreen 114.

The mobile device 104 may convert 206 the user input 125 to a 2D instruction 123 for moving the vehicle 102. The 2D instruction 123 may include a motion vector mapped to a ground plane of the vehicle 102. The 2D instruction 123 may also include an instruction to park the vehicle 102. Converting 206 the user input to the 2D instruction 123 may include mapping the user input 125 in the 3D surround view 116 to a motion vector in a 2D bird's-eye view of the vehicle 102. This may be accomplished as described in connection with FIGS. 13-14.

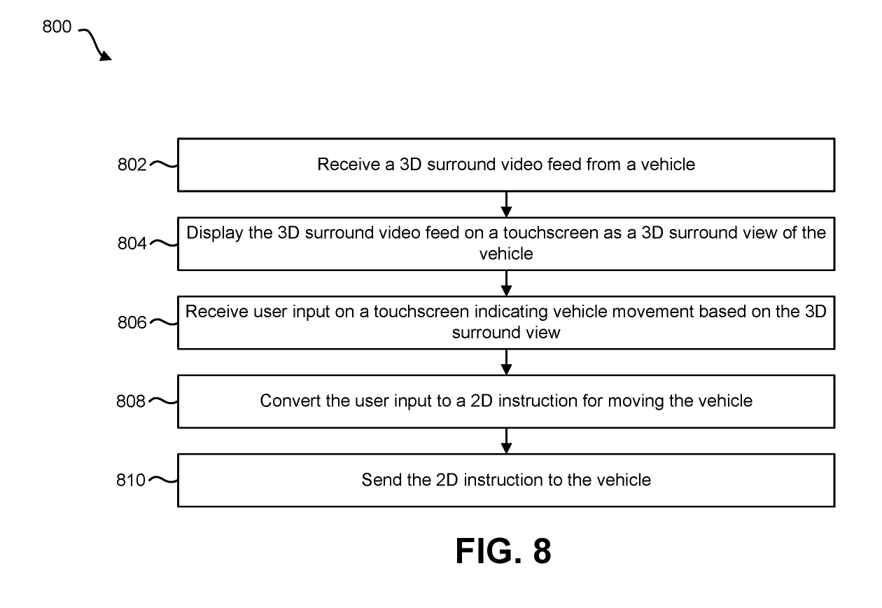

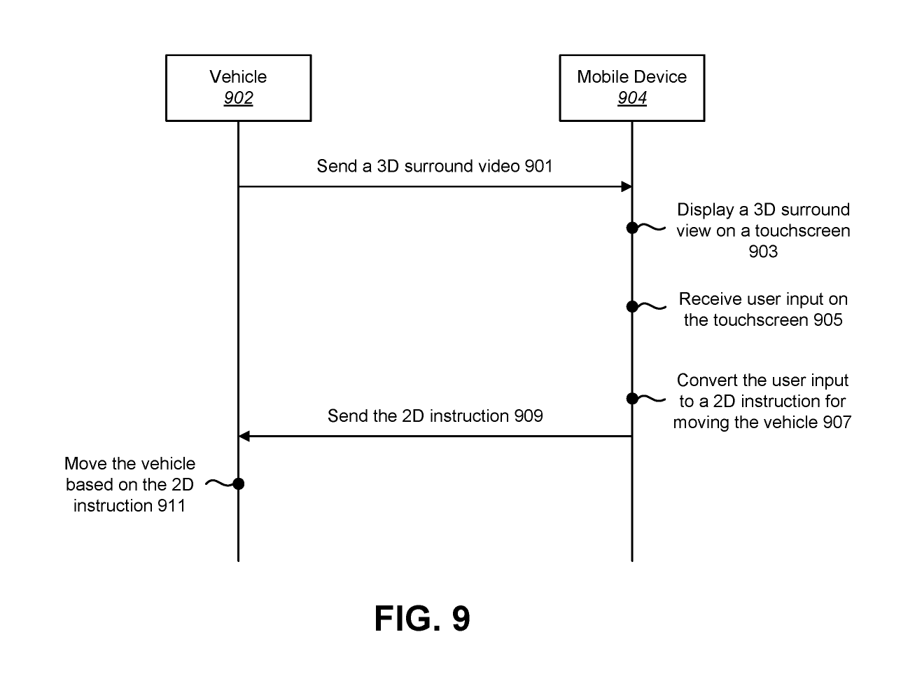

In an approach, the mobile device 104 may perform the conversion 206 to determine the 2D instructions 123. This approach is described in connection with FIGS. 8-9.

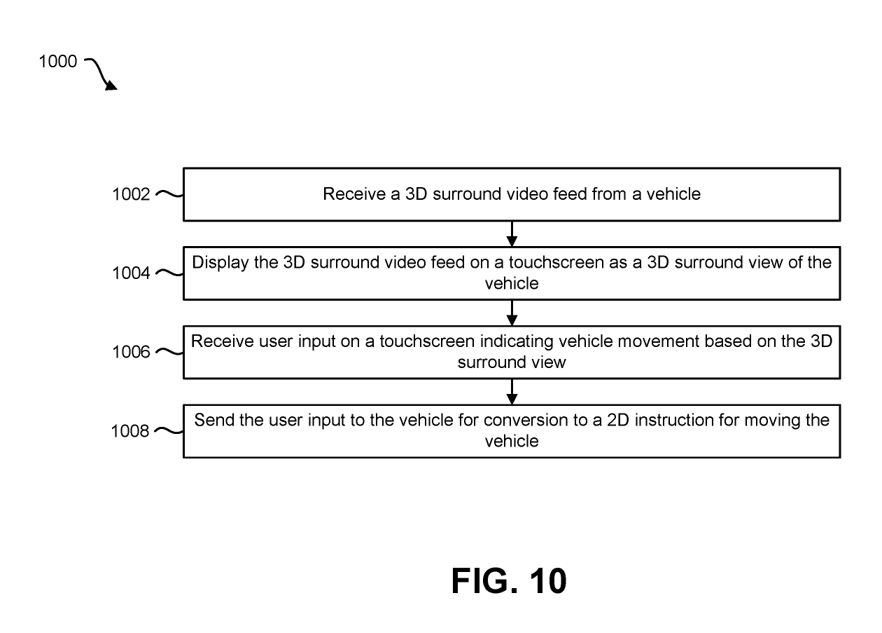

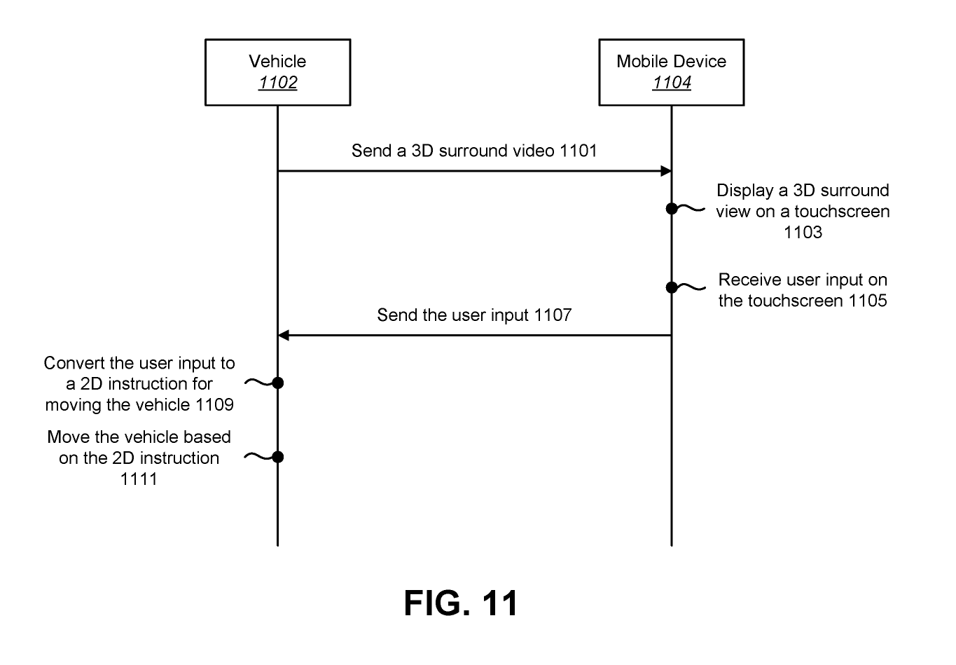

In another approach, the conversion 206 includes sending the user input 125 to the vehicle 102. The vehicle 102 then converts 206 the user input 125 from the 3D surround view 116 to the 2D instruction. This approach is described in connection with FIGS. 10-11.

FIG. 3 is a diagram illustrating one example of a top plan view or bird's-eye view image visualization 328. A display system may be implemented to show an image visualization. Examples of display systems may include the touchscreen 114 described in connection with FIG. 1.

In the example shown in FIG. 3, a vehicle 302 includes four cameras 106. A front camera 106 captures a forward scene 330a, a right side camera 106 captures a right scene 330b, a rear camera 106 captures a rear scene 330c, and a left side camera 106 captures a left scene 330d. In an approach, the images of the scenes 330a-d may be combined to form a 2D bird's-eye view image visualization 328. As can be observed, the bird's-eye view image visualization 328 focuses on the area around the vehicle 302. It should be noted that the vehicle 302 may be depicted as a model or representation of the actual vehicle 302 in an image visualization.

One disadvantage of the bird's-eye view image visualization 328 is that some objects may appear to be flattened or distorted and may lack a sense of height or depth. For example, a group of barriers 334, a person 336, and a tree 338 may look flat. In a scenario where a driver is viewing the bird's-eye view visualization 328, the driver may not register the height of one or more objects. This could even cause the driver to collide the vehicle 302 with an object (e.g., a barrier 334) because the bird's-eye view visualization 328 lacks a portrayal of height.

FIG. 4 is a diagram illustrating one example of a 3D surround view 416. In an implementation, images from multiple cameras 106 may be combined to produce a combined image. In this example, the combined image is conformed to a rendering geometry 442 in the shape of a bowl to produce the 3D surround view image visualization 416. As can be observed, the 3D surround view image visualization 416 makes the ground around the vehicle 402 (e.g., vehicle model, representation, etc.) appear flat, while other objects in the image have a sense of height. For example, barriers 434 in front of the vehicle 402 each appear to have height (e.g., 3 dimensions, height, depth) in the 3D surround view image visualization 416. It should be noted that the vehicle 402 may be depicted as a model or representation of the actual vehicle 402 in an image visualization.

It should also be noted that the 3D surround view image visualization 416 may distort one or more objects based on the shape of the rendering geometry 442 in some cases. For example, if the “bottom” of the bowl shape of the rendering geometry 442 in FIG. 4 were larger, the other vehicles may have appeared flattened. However, if the “sides” of the bowl shape of the rendering geometry 442 were larger, the ground around the vehicle 402 may have appeared upturned, as if the vehicle 402 were in the bottom of a pit. Accordingly, the appropriate shape of the rendering geometry 442 may vary based on the scene. For example, if an object (e.g., an object with at least a given height) is closer to the image sensor, a rendering geometry with a smaller bottom (e.g., base diameter) may avoid flattening the appearance of the object. However, if the scene depicts an open area where tall objects are not near the image sensor, a rendering geometry with a larger bottom (e.g., base diameter) may better depict the scene.

In some configurations of the systems and methods disclosed herein, multiple wide angle fisheye cameras 106 may be utilized to generate a 3D surround view 416. In an implementation, the 3D surround view 416 may be adjusted and/or changed based on the scene (e.g., depth information of the scene). The systems and methods disclosed herein may provide a 3D effect (where certain objects may appear to “pop-up,” for example). Additionally or alternatively, the image visualization may be adjusted (e.g., updated) dynamically to portray a city view (e.g., a narrower view in which one or more objects are close to the cameras) or a green field view (e.g., a broader view in which one or more objects are further from the cameras). Additionally or alternatively, a region of interest (ROI) may be identified and/or a zoom capability may be set based on the depth or scene from object detection. In this example, the vehicle 402 may obtain depth information indicating that the nearest object (e.g., a barrier 434) is at a medium distance (e.g., approximately 3 m) from the vehicle 402.

As can be observed in FIG. 4, a transition edge 446 of the rendering geometry 442 may be adjusted such that the base diameter of the rendering geometry 442 extends nearly to the nearest object. Additionally, the viewpoint may be adjusted such that the viewing angle is perpendicular to the ground (e.g., top-down), while being above the vehicle 402. These adjustments allow the combined 3D surround view 416 to show around the entire vehicle perimeter, while still allowing the trees and building to have a sense of height. This may assist a driver in navigating in a parking lot (e.g., backing up, turning around objects at a medium distance, etc.).

In an implementation, the mobile device 104 may display a motion vector 448 in the 3D surround view 416. The motion vector 448 may be generated based on user input 125 indicating vehicle motion. For example, the user may drag the virtual vehicle 402 on the touchscreen 114 in a certain direction. The mobile device 104 may display the motion vector 448 as visual feedback to the user to assist in maneuvering the vehicle 402.

In an implementation, the vehicle 402 may generate the 3D surround view 416 by combining multiple images. For example, multiple images may be stitched together to form a combined image. The multiple images used to form the combined image may be captured from a single image sensor (e.g., one image sensor at multiple positions (e.g., angles, rotations, locations, etc.)) or may be captured from multiple image sensors (at different locations, for example). As described above, the image(s) may be captured from the camera(s) 106 included in the mobile device 104 or may be captured from one or more remote camera(s) 106.

The vehicle 402 may perform image alignment (e.g., registration), seam finding and/or merging. Image alignment may include determining an overlapping area between images and/or aligning the images. Seam finding may include determining a seam in an overlapping area between images. The seam may be generated in order to improve continuity (e.g., reduce discontinuity) between the images. For example, the vehicle 402 may determine a seam along which the images match well (e.g., where edges, objects, textures, color and/or intensity match well). Merging the images may include joining the images (along a seam, for example) and/or discarding information (e.g., cropped pixels).

It should be noted that in some configurations, the image alignment (e.g., overlapping area determination) and/or the seam finding may be optional. For example, the cameras 106 may be calibrated offline such that the overlapping area and/or seam are predetermined. In these configurations, the images may be merged based on the predetermined overlap and/or seam.

In an implementation, the vehicle 402 may obtain depth information. This may be performed based on multiple images (e.g., stereoscopic depth determination), motion information, and/or other depth sensing. In some approaches, one or more cameras 106 may be depth sensors and/or may be utilized as depth sensors. In some configurations, for example, the vehicle 402 may receive multiple images. The vehicle 402 may triangulate one or more objects in the images (in overlapping areas of the images, for instance) to determine the distance between a camera 106 and the one or more objects. For example, the 3D position of feature points (referenced in a first camera coordinate system) may be calculated from two (or more) calibrated cameras. Then, the depth may be estimated through triangulation.

In some configurations, the vehicle 402 may obtain depth information by utilizing one or more additional or alternative depth sensing approaches. For example, the vehicle 402 may receive information from a depth sensor (in addition to or alternatively from one or more visual spectrum cameras 106) that may indicate a distance to one or more objects. Examples of other depth sensors include time-of-flight cameras (e.g., infrared time-of-flight cameras), interferometers, radar, LIDAR, sonic depth sensors, ultrasonic depth sensors, etc. One or more depth sensors may be included within, may be coupled to, and/or may be in communication with the vehicle 402 in some configurations. The vehicle 402 may estimate (e.g., compute) depth information based on the information from one or more depth sensors and/or may receive depth information from the one or more depth sensors. For example, the vehicle 402 may receive time-of-flight information from a time-of-flight camera and may compute depth information based on the time-of-flight information.

A rendering geometry 442 may be a shape onto which an image is rendered (e.g., mapped, projected, etc.). For example, an image (e.g., a combined image) may be rendered in the shape of a bowl (e.g., bowl interior), a cup (e.g., cup interior), a sphere (e.g., whole sphere interior, partial sphere interior, half-sphere interior, etc.), a spheroid (e.g., whole spheroid interior, partial spheroid interior, half-spheroid interior, etc.), a cylinder (e.g., whole cylinder interior, partial cylinder interior, etc.), an ellipsoid (e.g., whole ellipsoid interior, partial ellipsoid interior, half-ellipsoid interior, etc.), polyhedron (e.g., polyhedron interior, partial polyhedron interior, etc.), trapezoidal prism (e.g., trapezoidal prism interior, partial trapezoidal prism interior, etc.), etc. In some approaches, a “bowl” (e.g., multilayer bowl) shape may be a (whole or partial) sphere, spheroid or ellipsoid with a flat (e.g., planar) base. A rendering geometry 442 may or may not be symmetrical. It should be noted that the vehicle 402 or the mobile device 104 may insert a model (e.g., 3D model) or representation of the vehicle 402 (e.g., car, drone, etc.) in a 3D surround view 416. The model or representation may be predetermined in some configurations. For example, no image data may be rendered on the model in some configurations.

Some rendering geometries 442 may include an upward or vertical portion. For example, at least one “side” of bowl, cup, cylinder, box or prism shapes may be the upward or vertical portion. For example, the upward or vertical portion of shapes that have a flat base may begin where the base (e.g., horizontal base) transitions or begins to transition upward or vertical. For example, transition (e.g., transition edge) of a bowl shape may be formed where the flat (e.g., planar) base intersects with the curved (e.g., spherical, elliptical, etc.) portion. It may be beneficial to utilize a rendering geometry 442 with a flat base, which may allow the ground to appear more natural. Other shapes (e.g., sphere, ellipsoid, etc.) may be utilized that may have a curved base. For these shapes (and/or for shapes that have a flat base), the upward or vertical portion may be established at a distance from the center (e.g., bottom center) of the rendering geometry 442 and/or a portion of the shape that is greater than or equal to a particular slope. Image visualizations in which the outer edges are upturned may be referred to as “surround view” image visualizations.

Adjusting the 3D surround view 416 based on the depth information may include changing the rendering geometry 442. For example, adjusting the 3D surround view 416 may include adjusting one or more dimensions and/or parameters (e.g., radius, diameter, width, length, height, curved surface angle, corner angle, circumference, size, distance from center, etc.) of the rendering geometry 442. It should be noted that the rendering geometry 442 may or may not be symmetric.

The 3D surround view 416 may be presented from a viewpoint (e.g., perspective, camera angle, etc.). For example, the 3D surround view 416 may be presented from a top-down viewpoint, a back-to-front viewpoint (e.g., raised back-to-front, lowered back-to-front, etc.), a front-to-back viewpoint (e.g., raised front-to-back, lowered front-to-back, etc.), an oblique viewpoint (e.g., hovering behind and slightly above, other angled viewpoints, etc.), etc. Additionally or alternatively, the 3D surround view 416 may be rotated and/or shifted.

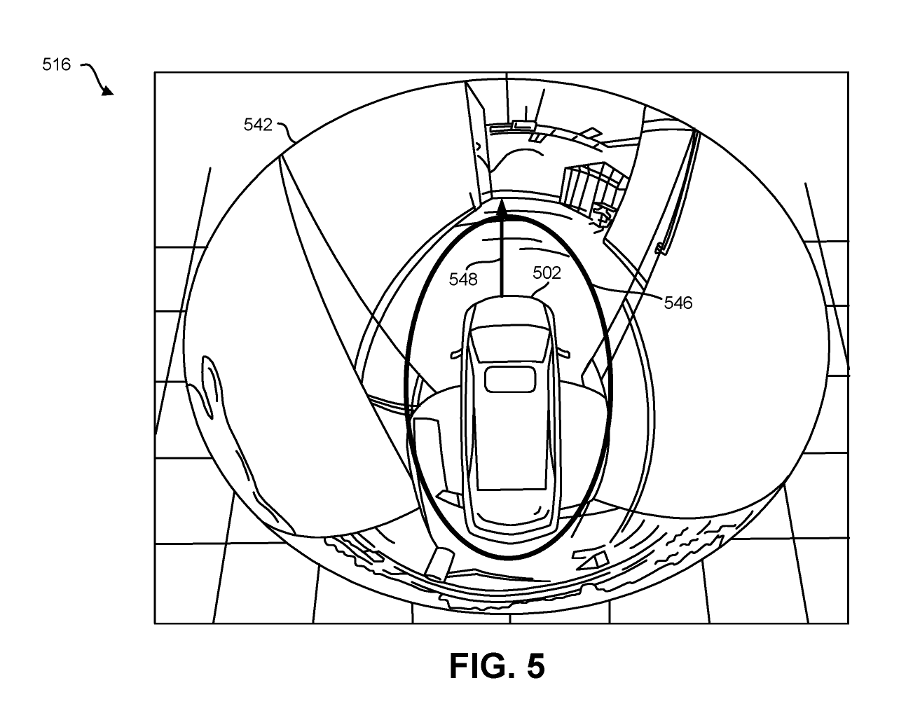

FIG. 5 illustrates another example of a 3D surround view 516 in accordance with the systems and methods disclosed herein. The 3D surround view 516 is a surround view (e.g., bowl shape). In this example, a vehicle 502 may include several cameras 106 (e.g., 4: one mounted to the front, one mounted to the right, one mounted to the left, and one mounted to the rear). Images taken from the cameras 106 may be combined as described above to produce a combined image. The combined image may be rendered on a rendering geometry 542.

In this example, the vehicle 502 may obtain depth information indicating that the nearest object (e.g., a wall to the side) is at a close distance (e.g., approximately 1.5 m) from the vehicle 502. As can be further observed, the distance to the nearest object in front of the vehicle 502 is relatively great (approximately 8 m). In this example, the base of the rendering geometry 542 may be adjusted to be elliptical in shape, allowing the 3D surround view 516 to give both the walls to the sides of the vehicle 502 and the wall in front of the vehicle 502 a sense of height, while reducing the appearance of distortion on the ground.

As can be observed in FIG. 5, a transition edge 546 of the rendering geometry 542 may be adjusted such that the base length of the rendering geometry 542 extends nearly to the wall in front of the vehicle 502 and the base width of the rendering geometry 542 extends nearly to the wall on the side of the vehicle 502. Additionally, the viewpoint may be adjusted such that the viewing angle is high to the ground (e.g., approximately 70 degrees), while being above the vehicle 502. These adjustments allow the 3D surround view 516 to emphasize how close the wall is, while allowing the wall to have a sense of height. This may assist a driver in navigating in a close corridor or garage.

In an implementation, the mobile device 104 may display a motion vector 548 in the 3D surround view 516. This may be accomplished as described in connection with FIG. 4.

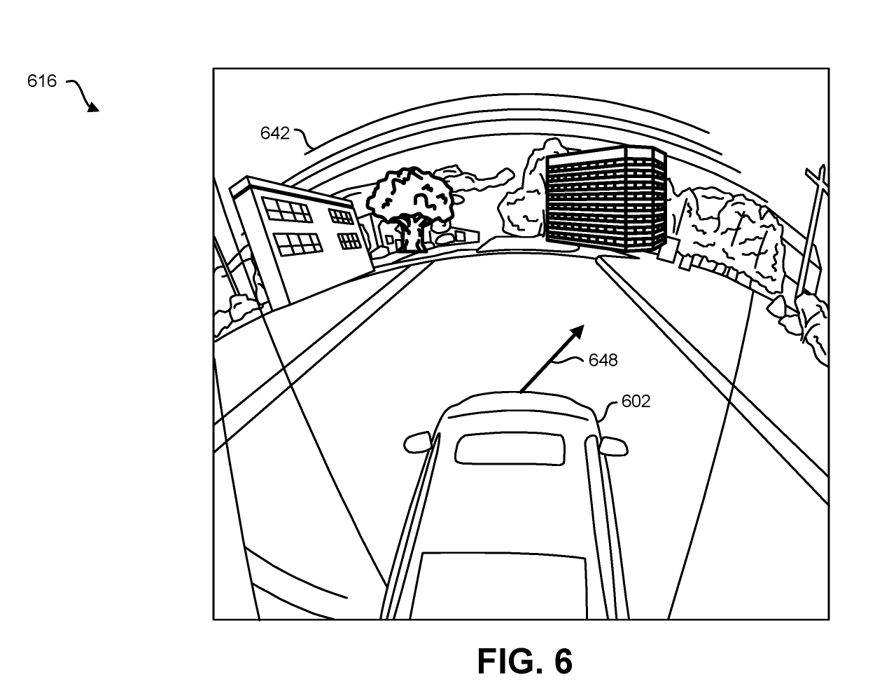

FIG. 6 illustrates yet another example of a 3D surround view 616 in accordance with the systems and methods disclosed herein. The 3D surround view 616 is a surround view (e.g., bowl shape). In this example, a vehicle 602 may include several cameras 106 (e.g., 4: one mounted to the front, one mounted to the right, one mounted to the left, and one mounted to the rear). Images taken from the cameras 106 may be combined as described above to produce a combined image. The combined image may be rendered on a rendering geometry 642.

In an implementation, the mobile device 104 may display a motion vector 648 in the 3D surround view 616. This may be accomplished as described in connection with FIG. 4.

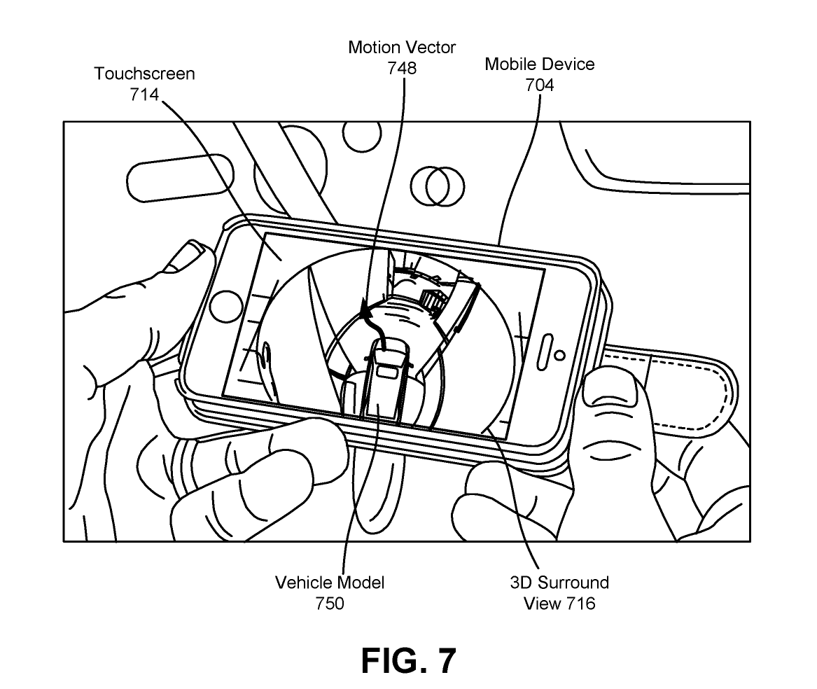

FIG. 7 illustrates an example of a mobile device 704 configured to control a vehicle 102 in accordance with the systems and methods disclosed herein. The mobile device 704 may be implemented in accordance with the mobile device 104 described in connection with FIG. 1.

In this example, the mobile device 704 is a smart phone with a touchscreen 714. The mobile device 704 may receive a 3D surround video feed 112 from the vehicle 102. The mobile device 704 displays a 3D surround view 716 on the touchscreen 714. A virtual vehicle model 750 is displayed in the 3D surround view 716.

The user may interact with the 3D surround view 716 on the touchscreen 714 to indicate vehicle movement. For example, the user may drag the vehicle model 750 in a desired trajectory. This user input 125 may be converted to a 2D instruction 123 for moving the vehicle 102 as described in connection with FIG. 1.

In this example, the mobile device 704 displays a motion vector 748 in the 3D surround view 716 on the touchscreen 714. The motion vector 748 may be used as visual feedback to the user to demonstrate the projected motion of the vehicle 102.

FIG. 8 is a flow diagram illustrating another method 800 for controlling a vehicle 102 using a mobile device 104. The method 800 may be implemented by a mobile device 104 that is configured to communicate with a vehicle 102.

The mobile device 104 may receive 802 a three-dimensional (3D) surround video feed 112 from the vehicle 102. The 3D surround video feed 112 may include a 3D surround view 116 of the vehicle 102.

The mobile device 104 may display 804 the 3D surround video feed 112 on the touchscreen 114 as a 3D surround view 116 of the vehicle 102. The 3D surround view 116 may be a composite view of multiple images captured by a plurality of cameras 106 on the vehicle 102. The vehicle 102 may combine the different views into a 3D surround view 116.

The mobile device 104 may receive 806 user input 125 on a touchscreen 114 indicating vehicle movement based on the 3D surround view 116. The user may interact with the 3D surround view 116 on the touchscreen 114 to indicate vehicle motion. This may be accomplished as described in connection with FIG. 2.

The mobile device 104 may convert 808 the user input 125 to a 2D instruction 123 for moving the vehicle 102. The mobile device 104 may map the user input 125 in the 3D surround view 116 to a motion vector in a 2D bird's-eye view of the vehicle 102. The 2D instruction 123 may include the motion vector mapped to a ground plane of the vehicle 102.

In an approach, the mobile device 104 may determine a first motion vector corresponding to the user input 125 on the touchscreen 114. The mobile device 104 may apply a transformation to the first motion vector to determine a second motion vector that is aligned with a ground plane of the vehicle 102. The transformation may be based on a lens focal length of the 3D surround view 116 as described in connection with FIG. 14.

The mobile device 104 may send 810 the 2D instruction 123 to the vehicle 102. The vehicle 102 may move itself based on the 2D instruction 123.

FIG. 9 is a sequence diagram illustrating a procedure for controlling a vehicle 902 using a mobile device 904. The vehicle 902 may be implemented in accordance with the vehicle 102 described in connection with FIG. 1. The mobile device 904 may be implemented in accordance with the mobile device 104 described in connection with FIG. 1.

The vehicle 902 may send 901 a three-dimensional (3D) surround video feed 112 to the mobile device 904. For example, the vehicle 902 may include a plurality of cameras 106 that capture an image of the environment surrounding the vehicle 902. The vehicle 902 may generate a composite 3D surround view 116 from these images. The vehicle 902 may send 901 a sequence of the 3D surround view 116 as the 3D surround video feed 112.

The mobile device 904 may display 903 the 3D surround view 116 on the touchscreen 114. The mobile device 904 may receive 905 user input 125 on a touchscreen 114 indicating vehicle movement based on the 3D surround view 116.

The mobile device 904 may convert 907 the user input 125 to a 2D instruction 123 for moving the vehicle 902. For example, the mobile device 904 may map the user input 125 in the 3D surround view 116 to a motion vector in a 2D bird's-eye view of the vehicle 902. The 2D instruction 123 may include the motion vector mapped to a ground plane of the vehicle 902.

The mobile device 904 may send 909 the 2D instruction 123 to the vehicle 902. Upon receiving the 2D instruction 123, the vehicle 902 may move 911 based on the 2D instruction 123.

FIG. 10 is a flow diagram illustrating yet another method 1000 for controlling a vehicle 102 using a mobile device 104. The method 1000 may be implemented by a mobile device 104 that is configured to communicate with a vehicle 102.

The mobile device 104 may receive 1002 a three-dimensional (3D) surround video feed 112 from the vehicle 102. The 3D surround video feed 112 may include a 3D surround view 116 of the vehicle 102.

The mobile device 104 may display 1004 the 3D surround video feed 112 on the touchscreen 114 as a 3D surround view 116 of the vehicle 102. The mobile device 104 may receive 1006 user input 125 on a touchscreen 114 indicating vehicle movement based on the 3D surround view 116. The user may interact with the 3D surround view 116 on the touchscreen 114 to indicate vehicle motion. This may be accomplished as described in connection with FIG. 2.

The mobile device 104 may send 1008 the user input 125 to the vehicle 102 for conversion to a 2D instruction for moving the vehicle 102. In this approach, the vehicle 102, not the mobile device 104, performs the conversion. Therefore, the mobile device 104 may provide user input 125 data to the vehicle 102, which performs the 3D-to-2D conversion and performs a movement based on the 2D instruction.

FIG. 11 is a sequence diagram illustrating another procedure for controlling a vehicle 1102 using a mobile device 1104. The vehicle 1102 may be implemented in accordance with the vehicle 102 described in connection with FIG. 1. The mobile device 1104 may be implemented in accordance with the mobile device 104 described in connection with FIG. 1.

The vehicle 1102 may send 1101 a three-dimensional (3D) surround video feed 112 to the mobile device 1104. For example, the vehicle 1102 may generate a composite 3D surround view 116 from images captured by a plurality of cameras 106.

The mobile device 1104 may display 1103 the 3D surround view 116 on the touchscreen 114. The mobile device 1104 may receive 1105 user input 125 on a touchscreen 114 indicating vehicle movement based on the 3D surround view 116. The mobile device 1104 may send 1107 the user input 125 to the vehicle 1102.

Upon receiving the user input 125, the vehicle 1102 may convert 1109 the user input 125 to a 2D instruction for moving the vehicle 1102. For example, the vehicle 1102 may map the user input 125 in the 3D surround view 116 to a motion vector in a 2D bird's-eye view of the vehicle 1102. The 2D instruction may include the motion vector mapped to a ground plane of the vehicle 1102. The vehicle 1102 may move 1111 based on the 2D instruction.

FIG. 12 illustrates a bird's-eye view 1228 and a 3D surround view 1216. To interactively maneuver the vehicle 102 from live video feeds the described systems and methods may use a touchscreen 114 to move a virtual vehicle in a 3D surround view 1216. Compared with a 3D surround view 1216, the non-ground-level objects, such as obstacles, will have distortion in the bird's-eye view 1228. Also there are amplified variations in the farther surrounding area of a bird's-eye view 1228. The 3D surround view 1216 provides height and depth visual information that is not visible in a bird's-eye view 1228.

In FIG. 12, a bird's-eye view 1228 illustrates an un-warped 3D view. The bird's-eye view 1228 may be a composite view that combines images from a plurality of cameras 106. The bird's-eye view 1228 has a ground plane 1255 and four vertical planes 1256a-d. It should be noted that in the bird's-eye view 1228, there is significant distortion at the seams (e.g., corners) of the vertical planes 1256a-d.

In a second approach, warping the composite image in a distortion level by placing a virtual fisheye camera in the 3D view can cope with this distortion problem. In the 3D surround view 1216, the composite image is warped to decrease the amount of distortion that occurs at the composite image seams. This results in a circular shape as the vertical planes 1260a-d are warped. The ground plane 1258 is also warped.

Since the 3D surround view 1216 is a warped view with distortion, the mapped trajectory is not aligned with real scenes. In other words, accurate 2D instructions 123 must account for this warping and distortion. FIGS. 13 and 14 describe approaches to convert points on the 3D surround view 1216 to a 2D bird's-eye view 1228 that may be used to accurately control the motion of a vehicle 102.

FIG. 13 illustrates an approach to map points in a 3D surround view 1316 to a 2D bird's-eye view 1328. A 3D surround view 1316 may be displayed on a touchscreen 114 of a mobile device 104. The 3D surround view 1316 shows a virtual vehicle model of the vehicle 1302. The user may drag the virtual vehicle model 1302 from a first point (A) 1354a to a second point (B) 1354b in the 3D surround view 1316. Therefore, the trajectory on the 3D surround view 1316 has a starting point A 1354a and an end point B 1354b. These positions may be expressed as (xₐ,yₐ) and (x_{b},y_{b}), where xₐ is the X-axis coordinate of point-A 1354a, yₐ is the Y-axis coordinate of point A 1354a, x_{b} is the X-axis coordinate of point-B 1354b and m is the Y-axis coordinate of point B 1354b. A first motion vector (M) 1348a may connect point A 1354a and point B 1354b.

The 3D surround view 1316 can be generated from or related to a 2D bird's-eye view 1328. Therefore, the point matching of point A 1354a and point B 1354b to a corresponding point-A′ 1356a and point-B′ 1356b in the 2D bird's-eye view 1328 will be a reverse mapping. The adjusted point-A′ 1356a and adjusted point-B′ 1356b are mapped to the 2D ground plane 1355 in relation to the vehicle 1302. A second motion vector (M′) 1348b corresponds to the adjusted point A′ 1356a and point B′ 1356b.

It should be noted that the 2D bird's-eye view 1328 is illustrated for the purpose of explaining the conversion of user input 125 in the 3D surround view 1316 to a 2D instruction 123. However, the 2D bird's-eye view 1328 need not be generated or displayed on the mobile device 104 or the vehicle 102.

In an implementation, the second motion vector (M′) 1348b may be determined by applying a transformation to the first motion vector (M) 1348a. This may be accomplished by applying a mapping model to the starting point-A 1354a and the end point-B 1354b of the 3D surround view 1316. This may be accomplished as described in connection with FIG. 14.

In another implementation, the starting point-A 1354a may be fixed at a certain location (e.g., origin) in the 3D surround view 1316. As the user drags the virtual vehicle model in the 3D surround view 1316, the motion vector 1348b may be determined based on a conversion of the end point-B 1354b to the 2D bird's-eye view 1328.

FIG. 14 illustrates an approach to map a point in a 3D surround view 1416 to a 2D bird's-eye view 1428. This approach may be used to convert the user input 125 from a 3D surround view 1416 to a 2D instruction 123.

A fisheye lens may be used as the virtual camera(s) that capture the 3D surround view 1416. Therefore, the 3D surround view 1416 may be assumed to be a fisheye image. In this case, a fisheye lens has an equidistance projection and a focal lens f. The 2D bird's-eye view 1428 may be referred to as a standard image.

The 3D surround view 1416 is depicted with an X-axis 1458 and a Y-axis 1460, an origin (O_{f}) 1462a and an image circle 1462. The image circle 1462 is produced by a circular fisheye lens. The 2D bird's-eye view 1428 is also depicted with an X-axis 1458, a Y-axis 1460 and an origin (Oₛ) 1462b. The point mapping is P_{f}=(l_{fx},l_{fy}) 1454 (in the 3D surround view 1416) to Pₛ=(lₛₓ,l_{sy}) 1456 (in the 2D bird's-eye view 1428). The mapping equations are as follow:

$$\begin{matrix}{l}_{f} = \sqrt{{( {l}_{fx} )}^{2} + {( {l}_{fy} )}^{2}} & ( 1 ) \\ {l}_{s} = f \cdot tan ( \frac{{l}_{f}}{f} ) & ( 2 ) \\ {l}_{sx} = {l}_{s} \cdot \frac{{l}_{fx}}{{l}_{f}} & ( 3 ) \\ {l}_{sy} = {l}_{s} \cdot \frac{{l}_{fx}}{{l}_{f}} & ( 4 )\end{matrix}$$

For a given point in the 3D surround view 1416, the corresponding coordinates in the 2D bird's-eye view 1428 may be determined by applying Equations 1-4. Given point-A′ 1456a and point-B′ 1456b, the motion vector 1448 (M′, α) will be obtained on the ground plane. The vehicle 102 will be moved accordingly. In this Figure, M′ 1448 is the 2D translation and α 1464 is the 2D rotation.

It should be noted that there are several mapping models from fisheye to perspective 2D bird's-eye view 1428. While FIG. 14 provides one approach, other mapping models may be used to convert from the 3D surround view 1416 to the 2D bird's-eye view 1428.

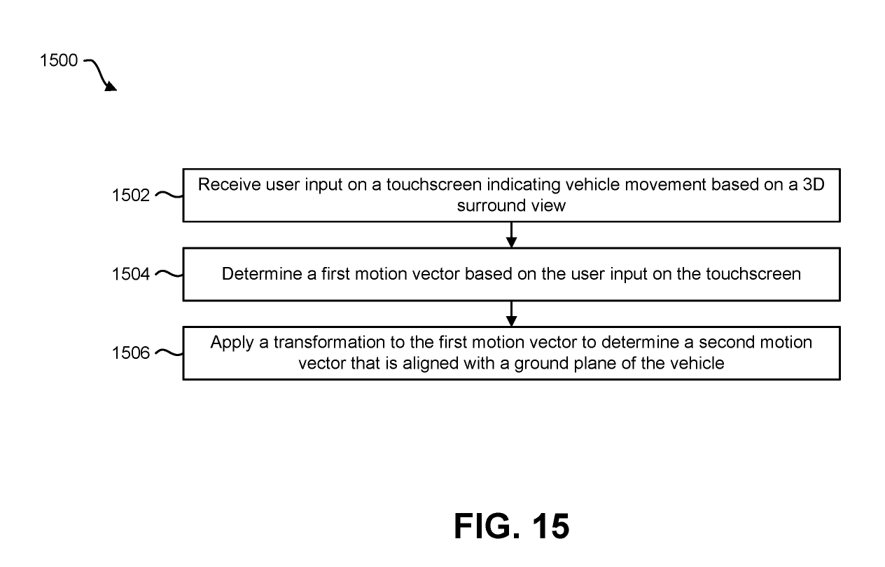

FIG. 15 is a flow diagram illustrating a method 1500 for converting a user input 125 on a touchscreen 114 of a mobile device 104 to a 2D instruction 123 for moving a vehicle 102. The method 1500 may be implemented by the mobile device 104 or the vehicle 102.

The mobile device 104 or the vehicle 102 may receive 1502 user input 125 to the touchscreen 114 of the mobile device 104. The user input 125 may indicate vehicle movement based on a 3D surround view 116. In an implementation, receiving 1502 the user input 125 may include determining a displacement of a virtual vehicle model in the 3D surround view 116 displayed on the touchscreen 114.

The mobile device 104 or the vehicle 102 may determine 1504 a first motion vector (M) 1348a based on the user input 125. The first motion vector (M) 1348a may be oriented in the 3D surround view 116. For example, the first motion vector (M) 1348a may have a first (i.e., start) point (A) 1354a and a second (i.e., end) point (B) 1354b in the 3D surround view 116.

The mobile device 104 or the vehicle 102 may apply 1506 a transformation to the first motion vector (M) 1348a to determine a second motion vector (M′) 1348b that is aligned with a ground plane 1355 of the vehicle 102. The transformation may be based on a lens focal length of the 3D surround view 116.

In an approach, Equations 1-4 may be applied to the first point (A) 1354a and the second point (B) 1354b to determine an adjusted first point (A′) 1356a and an adjusted second point (B′) 1356b that are aligned with the ground plane 1355 in the 2D bird's-eye view 1328. The second motion vector (M′) 1348b may be determined from the adjusted first point (A′) 1356a and the adjusted second point (B′) 1356b.

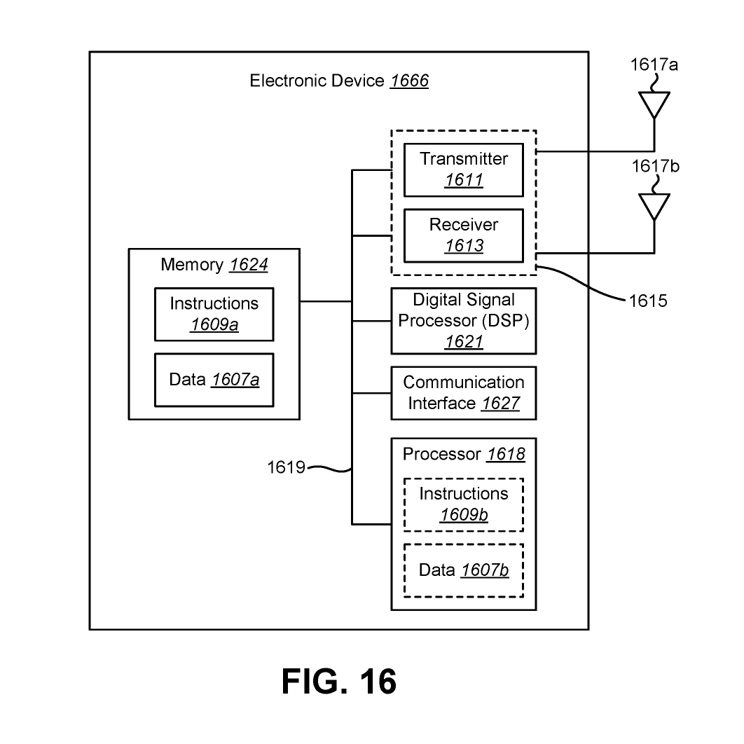

FIG. 16 illustrates certain components that may be included within an electronic device 1666. The electronic device 1666 described in connection with FIG. 16 may be an example of and/or may be implemented in accordance with the vehicle 102 or mobile device 104 described in connection with FIG. 1.

The electronic device 1666 includes a processor 1618. The processor 1618 may be a general purpose single- or multi-core microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1618 may be referred to as a central processing unit (CPU). Although just a single processor 1618 is shown in the electronic device 1666 of FIG. 16, in an alternative configuration, a combination of processors (e.g., an ARM and DSP) could be used.

The electronic device 1666 also includes memory 1624 in electronic communication with the processor 1618 (i.e., the processor can read information from and/or write information to the memory). The memory 1624 may be any electronic component capable of storing electronic information. The memory 1624 may be configured as Random Access Memory (RAM), Read-Only Memory (ROM), magnetic disk storage media, optical storage media, flash memory devices in RAM, on-board memory included with the processor, Erasable Programmable Read-Only Memory (EPROM), Electrically Erasable Programmable Read-Only Memory (EEPROM), registers and so forth, including combinations thereof.

Data 1607a and instructions 1609a may be stored in the memory 1624. The instructions 1609a may include one or more programs, routines, sub-routines, functions, procedures, code, etc. The instructions 1609a may include a single computer-readable statement or many computer-readable statements. The instructions 1609a may be executable by the processor 1618 to implement the methods disclosed herein. Executing the instructions 1609a may involve the use of the data 1607a that is stored in the memory 1624. When the processor 1618 executes the instructions 1609, various portions of the instructions 1609b may be loaded onto the processor 1618, and various pieces of data 1607b may be loaded onto the processor 1618.

The electronic device 1666 may also include a transmitter 1611 and a receiver 1613 to allow transmission and reception of signals to and from the electronic device 1666 via an antenna 1617. The transmitter 1611 and receiver 1613 may be collectively referred to as a transceiver 1615. As used herein, a “transceiver” is synonymous with a radio. The electronic device 1666 may also include (not shown) multiple transmitters, multiple antennas, multiple receivers and/or multiple transceivers.

The electronic device 1666 may include a digital signal processor (DSP) 1621. The electronic device 1666 may also include a communications interface 1627. The communications interface 1627 may allow a user to interact with the electronic device 1666.

The various components of the electronic device 1666 may be coupled together by one or more buses, which may include a power bus, a control signal bus, a status signal bus, a data bus, etc. For the sake of clarity, the various buses are illustrated in FIG. 16 as a bus system 1619.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. A method operable on a mobile device, comprising:
receiving a three-dimensional (3D) surround video feed from a vehicle, the 3D surround video feed comprising a 3D surround view of the vehicle;
receiving a user input on a touchscreen indicating vehicle movement based on the 3D surround view; and
converting the user input to a two-dimensional (2D) instruction for moving the vehicle, wherein the 2D instruction comprises a motion vector mapped to a ground plane of the vehicle.

2. The method of claim 1, further comprising sending the 2D instruction to the vehicle.

3. The method of claim 1, wherein converting the user input to the 2D instruction comprises sending the user input to the vehicle, wherein the vehicle converts the user input from the 3D surround view to the 2D instruction.

4. The method of claim 1, wherein the 2D instruction comprises an instruction to park the vehicle.

5. The method of claim 1, further comprising displaying the 3D surround video feed on the touchscreen.

6. The method of claim 1, wherein converting the user input to the 2D instruction comprises mapping the user input in the 3D surround view to a motion vector in a 2D bird's-eye view of the vehicle.

7. The method of claim 1, wherein converting the user input to the 2D instruction comprises:
determining a first motion vector based on the user input on the touchscreen; and
applying a transformation to the first motion vector to determine a second motion vector that is aligned with a ground plane of the vehicle, wherein the transformation is based on a lens focal length of the 3D surround view.

8. The method of claim 1, wherein receiving the user input on the touchscreen indicating vehicle movement comprises determining a displacement of a virtual vehicle model in the 3D surround view displayed on the touchscreen.

9. The method of claim 1, further comprising displaying a motion vector on the touchscreen corresponding to the converted user input.

10. A mobile device, comprising:
a processor;
a memory in communication with the processor; and
instructions stored in the memory, the instructions executable by the processor to:
receive a three-dimensional (3D) surround video feed from a vehicle, the 3D surround video feed comprising a 3D surround view of the vehicle;
receive a user input on a touchscreen indicating vehicle movement based on the 3D surround view; and
convert the user input to a two-dimensional (2D) instruction for moving the vehicle, wherein the 2D instruction comprises a motion vector mapped to a ground plane of the vehicle.

11. The mobile device of claim 10, further comprising instructions executable to send the 2D instruction to the vehicle.

12. The mobile device of claim 10, further comprising instructions executable to display the 3D surround video feed on the touchscreen.

13. The mobile device of claim 10, wherein the instructions executable to convert the user input to the 2D instruction comprise instructions executable to map the user input in the 3D surround view to a motion vector in a 2D bird's-eye view of the vehicle.

14. The mobile device of claim 10, wherein the instructions executable to convert the user input to the 2D instruction comprise instructions executable to:
determine a first motion vector based on the user input on the touchscreen; and
apply a transformation to the first motion vector to determine a second motion vector that is aligned with a ground plane of the vehicle, wherein the transformation is based on a lens focal length of the 3D surround view.

15. The mobile device of claim 10, wherein the instructions executable to receive the user input on the touchscreen indicating vehicle movement comprise instructions executable to determine a displacement of a virtual vehicle model in the 3D surround view displayed on the touchscreen.

16. The mobile device of claim 10, further comprising instructions executable to display a motion vector on the touchscreen corresponding to the converted user input.

17. An apparatus, comprising:
means for receiving a three-dimensional (3D) surround video feed from a vehicle, the 3D surround video feed comprising a 3D surround view of the vehicle;
means for receiving a user input on a touchscreen indicating vehicle movement based on the 3D surround view; and
means for converting the user input to a two-dimensional (2D) instruction for moving the vehicle, wherein the 2D instruction comprises a motion vector mapped to a ground plane of the vehicle.

18. The apparatus of claim 17, further comprising means for sending the 2D instruction to the vehicle.

19. The apparatus of claim 17, further comprising means for displaying the 3D surround video feed on the touchscreen.

20. The apparatus of claim 17, wherein the means for converting the user input to the 2D instruction comprise means for mapping the user input in the 3D surround view to a motion vector in a 2D bird's-eye view of the vehicle.

21. The apparatus of claim 17, wherein the means for converting the user input to the 2D instruction comprise:
means for determining a first motion vector based on the user input on the touchscreen; and
means for applying a transformation to the first motion vector to determine a second motion vector that is aligned with a ground plane of the vehicle, wherein the transformation is based on a lens focal length of the 3D surround view.

22. The apparatus of claim 17, wherein the means for receiving the user input on the touchscreen indicating vehicle movement comprise means for determining a displacement of a virtual vehicle model in the 3D surround view displayed on the touchscreen.

23. The apparatus of claim 17, further comprising means for displaying a motion vector on the touchscreen corresponding to the converted user input.

24. A computer readable medium storing computer executable code, comprising:
code for causing a mobile device to receive a three-dimensional (3D) surround video feed from a vehicle, the 3D surround video feed comprising a 3D surround view of the vehicle;
code for causing the mobile device to receive a user input on a touchscreen indicating vehicle movement based on the 3D surround view; and
code for causing the mobile device to convert the user input to a two-dimensional (2D) instruction for moving the vehicle, wherein the 2D instruction comprises a motion vector mapped to a ground plane of the vehicle.

25. The computer readable medium of claim 24, further comprising code for causing the mobile device to send the 2D instruction to the vehicle.

26. The computer readable medium of claim 24, further comprising code for causing the mobile device to display the 3D surround video feed on the touchscreen.

27. The computer readable medium of claim 24, wherein the code for causing the mobile device to convert the user input to the 2D instruction comprises code for causing the mobile device to map the user input in the 3D surround view to a motion vector in a 2D bird's-eye view of the vehicle.

28. The computer readable medium of claim 24, wherein the code for causing the mobile device to convert the user input to the 2D instruction comprises:
code for causing the mobile device to determine a first motion vector based on the user input on the touchscreen; and
code for causing the mobile device to apply a transformation to the first motion vector to determine a second motion vector that is aligned with a ground plane of the vehicle, wherein the transformation is based on a lens focal length of the 3D surround view.

29. The computer readable medium of claim 24, wherein the code for causing the mobile device to receive the user input on the touchscreen indicating vehicle movement comprises code for causing the mobile device to determine a displacement of a virtual vehicle model in the 3D surround view displayed on the touchscreen.

30. The computer readable medium of claim 24, further comprising code for causing the mobile device to display a motion vector on the touchscreen corresponding to the converted user input.
